(19) United States
(12) Patent Application Publication
(10) Pub. No.: US 2008/0101564 A1
(43) Pub. Date: May 1, 2008

(54) COMMUNICATION SYSTEM

(75) Inventor: Motohisa ARAKI, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/877,420

(22) Filed: Oct. 23, 2007

(30) Foreign Application Priority Data
Oct. 31, 2006 (JP) 2006296601

(51) Int. Cl. H04M 11/00; G06F 15/16

(52) U.S. Cl. 379/90.01; 709/204

(57) ABSTRACT

According to one embodiment, a communication system includes a first terminal connected to an IP network and communicates with a second terminal through the IP network and a server apparatus including a controller that controls a communication between the first and second terminals. The first terminal includes a transmitter that transmits an instruction data for activating an additional function in response to a request operation for activating the additional function while the first terminal communicates with the second terminal. The controller of the server apparatus analyzes a received data by the server apparatus. When it is analyzed that the received data includes the instruction data for activating the additional function, the controller performs the additional function based on the instruction data.

### CROSS-REFERENCE TO RELATED APPLICATIONS

This application is based upon and claims the benefit of priority from Japanese Patent Application No. 2006-296601, filed on Oct. 31, 2006, the entire contents of which are incorporated herein by reference.

### BACKGROUND

1. Field

One embodiment of the invention relates to a communication system such as an Internet Protocol (IP) telephone system that performs voice communications between communication terminals connected to an IP network and between a communication terminal connected to the IP network and a public network.

2. Description of the Related Art

In recent years, a network telephone system (IP telephone system) that transmits and receives an image and voice bidirectionally as packet data in real time through a packet network is widely used. The IP telephone system not only enables an extension-to-extension communication and an outside call originating and terminating to be performed in each of communication servers connected to the IP network, but also enables an extension communication and an outside call originating and terminating to be performed between the communication servers through the IP network. In the IP telephone system, Session Initiation Protocol (SIP) is widely used as a protocol for the IP telephone system.

Even in this kind of system, additional originating and terminating services such as transfer, conference telephone conversation, executed in a Private Branch Exchange (PBX) or a key service unit are strongly demanded. In the IP telephone system described above, the additional services can be executed under the initiative of a terminal.

In the IP telephone system described above, Japanese Patent Application Publication (KOKAI) No. 2006-135522 discloses a technique of making it possible to execute the additional services between terminals through a plurality of IP networks different in IP address system.

Incidentally, the IP telephone system described above handles packet data based on various types of communication protocols in addition to a communication between terminals through a plurality of IP networks. In this case, plural terminals with plural communication protocols mixed are controlled by a communication server through the IP network. However, additional services of transfer, etc., between terminals different in communication protocol are still at an examination stage and are not yet defined as a standard.

In the IP telephone system described above, to purchase a terminal for use, generally the user selects a terminal including necessary service functions at the point in time. Thus, to execute the additional services between terminals, if one terminal does not include the additional service function, the additional service may be unable to be executed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary drawing to show the schematic configuration of a communication system according to a first embodiment of the present invention;

FIG. 2 is an exemplary block diagram to show the functional configuration of a communication server shown in FIG. 1;

FIG. 3 is an exemplary drawing to show the storage contents of a terminal information database shown in FIG. 2;

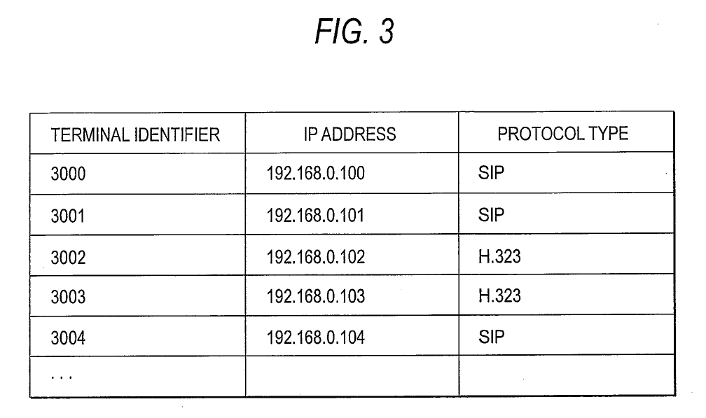

FIG. 4 is an exemplary sequence chart to show the operation to execute Consultation Hold control and transfer control between the communication server and terminals according to the first embodiment;

FIG. 5 is an exemplary drawing to show an example of the format of an INVITE message used according to the first embodiment; and

FIG. 6 is an exemplary sequence chart to show the operation to execute Consultation Hold control and conference control according to a second embodiment of the present invention.

### DETAILED DESCRIPTION

Various embodiments according to the invention will be described hereinafter with reference to the accompanying drawings. In general, according to one embodiment of the invention, there is provided a communication system includes: a first terminal connected to an IP network and communicates with a second terminal through the IP network, and a server apparatus includes a controller that controls a communication between the first and second terminals. The first terminal includes a transmitter that transmits an instruction data for activating an additional function in response to a request operation for activating the additional function while the first terminal communicates with the second terminal. The controller of the server apparatus analyzes a received data by the server apparatus. When it is analyzed that the received data includes the instruction data for activating the additional function, the controller performs the additional function based on the instruction data.

### First Embodiment

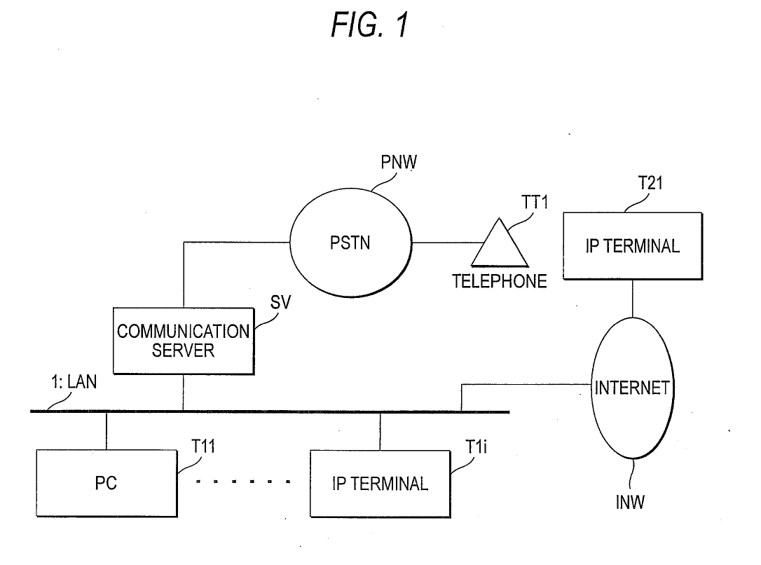

FIG. 1 is an exemplary drawing to show the schematic configuration of a communication system according to a first embodiment of the present invention.

The communication system includes the Internet INW and a LAN (Local Area Network) 1 as an IP network. Plural terminals T11 to T1i (where i is a natural number) are connected to the LAN 1. A terminal T21 is connected to the Internet INW. The terminals T11 to T1i (where i is a natural number) and T21 are IP telephone terminals each including a telephone conversation processing function and a media information processing function or soft phones implemented as software in personal computers.

A communication server SV is connected to the LAN 1. The communication server SV connects the LAN 1 and a public network PNW and also has an exchange control function for the terminals T11 to T1i and T21 and the public network PNW. An external telephone terminal TT1 is connected to the public network PNW.

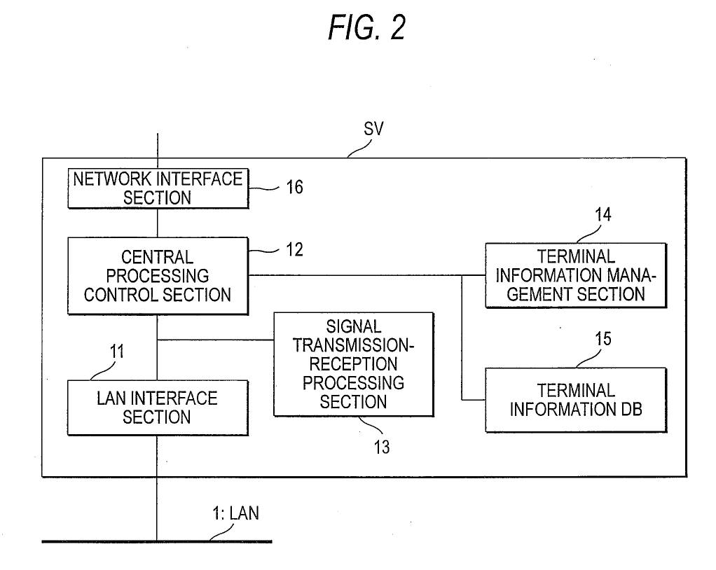

Incidentally, the communication server SV has the following functions. FIG. 2 is an exemplary block diagram to show the functional configuration of the communication server SV.

The communication server SV includes a LAN interface section 11, a central processing control section 12, a signal transmission-reception processing section 13, a terminal information management section 14, a terminal information database 15, and a network interface section 16. The LAN interface section 11 performs interface processing with the LAN 1.

The central processing control section 12 includes a CPU, a ROM, a RAM, etc., and controls the sections of the communication server SV by performing software processing.

The signal transmission-reception processing section 13 generates and analyzes a signal according to a communication protocol for each of the terminals T11 to T1i and T21 managed by the terminal information management section 14 and transmits the processing result to the central processing control section 12.

The terminal information management section 14 manages the terminal information database 15, accesses the terminal information database 15 to analyze a signal from the LAN 1, and transmits necessary information of a protocol type, etc., to the signal transmission-reception processing section 13.

The terminal information database 15 stores data representing the correspondence among terminal identifiers (terminal IDs), IP addresses both are assigned to the terminals T11 to T1i and T21, and available protocol types. Specifically, the terminal information database 15 stores a table respectively associating terminal IDs and communication protocols supported by the terminals T11 to T1i and T21.

The network interface section 16 performs interface processing with the public network PNW.

Incidentally, the central processing control section 12 includes an additional service execution control function. While communications are being performed between two of the terminals T11 to T1i, T21 or between one of the terminals T11 to T1i, T21 and the telephone terminal TT1 on the public network PNW, the additional service execution control function executes Consultation Hold control, transfer control, conference control, originating control for a special number, etc., in response to request operation to the communicating terminals T11 to T1i and T21.

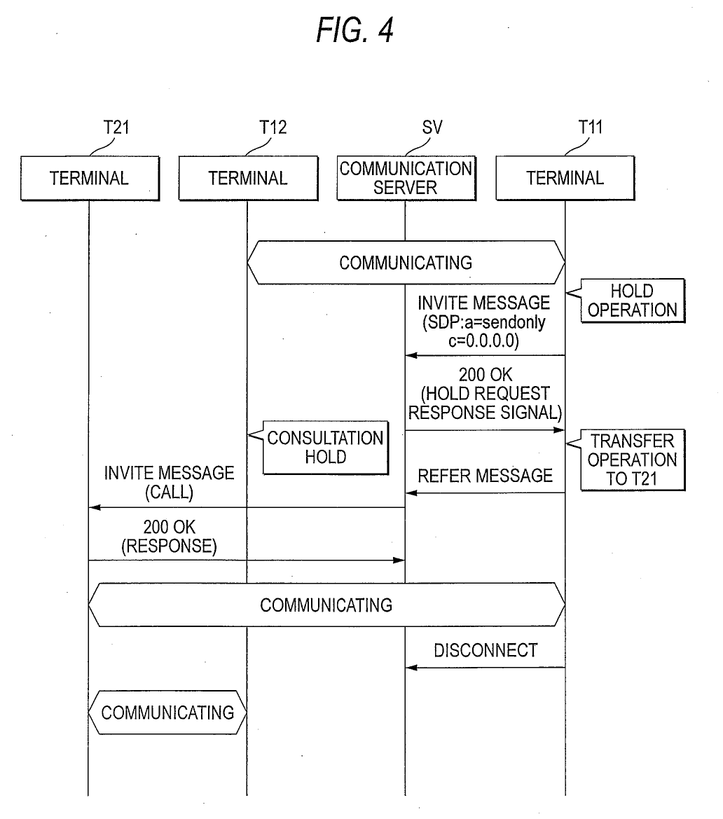

An operation of the communication system will be described. FIG. 4 is an exemplary sequence chart to show the operation to execute Consultation Hold control and transfer control.

Now, for example, assume that a voice communication are performed between the terminal T11 (terminal identifier: 3000) and the terminal T12 (terminal identifier: 3001).

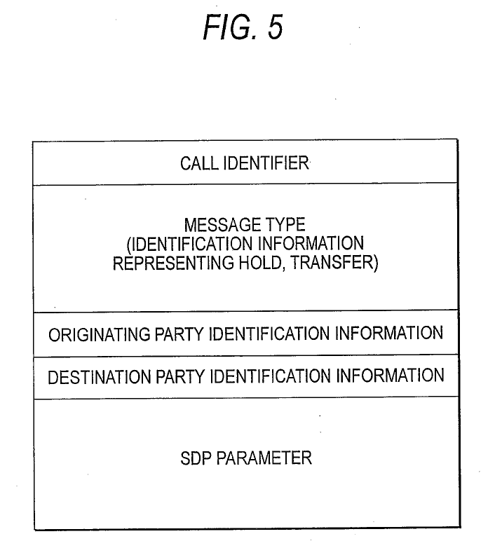

In this state, assume that a user performs a hold request operation to the terminal T11. Then, a request signal (INVITE message) is sent from the terminal T11 to the communication server SV. Upon reception of the request signal, the communication server SV refers the terminal information database 15 based on the IP addresses of the terminals T11 and T12 included in the request signal and determines a protocol of the request signal. For example, if the protocol of the terminal T11 is SIP and the request signal includes a=sendonly or c=0.0.0.0 in SDP parameter shown in FIG. 5, it is determined that the request signal is for hold operation. If the protocol of the terminal T11 is H.323 and the request signal includes a remote Hold Invoke ADPU signal of Facility, it is determined that the request signal is for hold operation. The determination is made according to the protocol. When the communication server SV is notified of the hold request operation, service of Consultation Hold that the communication server SV has, not terminal as in a related art, is started and a hold start response is returned to the terminal T11 while the communication link with the communicating terminal T12 is held.

Subsequently, assume that the user of the terminal T11 performs a communication transfer request operation from the terminal T11 to the terminal T21. Then, a REFER message is sent from the terminal T11 to the communication server SV.

Upon reception of the REFER message, the communication server SV refers the terminal information database 15 and determines whether or not the REFER message includes a parameter representing transfer. If a parameter representing transfer is included, it is determined that the REFER message is for transfer and a communication transfer service function is started.

The communication server SV calls the forward terminal T21 and when the terminal T21 responds, the communication server SV connects the terminals T11 and the terminal T21. In this state, if the user of the terminal T11 performs disconnection operation (on-hook), the terminals T12 and the terminal T21 are connected and the communication link with the terminal T11 is disconnected.

Thus, the party with which the terminal T12 communicates is switched from the terminal T11 to the terminal T21, enabling a user of the terminal T12 to perform a voice communication with a user of the terminal T21.

As described above, in the first embodiment, if a request operation for starting (activating) Consultation Hold and communication transfer is performed during communications with the terminal T12 at the terminal T11, information to start Consultation Hold and communication transfer is sent from the terminal T11 to the communication server SV, which then executes requested Consultation Hold and communication transfer using the received information.

Therefore, the Consultation Hold and the communication transfer for the terminal T11, T12 are implemented by the Consultation Hold and the communication transfer that the communication server SV has, so that if either of the terminals T11 and T12 does not include a function to start Consultation Hold and communication transfer or the terminals different in communication protocol, additional services of Consultation Hold, transfer, etc., can be implemented.

According to the first embodiment, the communication server SV determines whether or not execution of requested additional service is permitted, etc., using the information concerning the protocols of the terminals T11 to T1i and T21 stored and managed in the terminal information database 15. Therefore, an appropriate additional service execution processing can be performed by a simple procedure.

### Second Embodiment

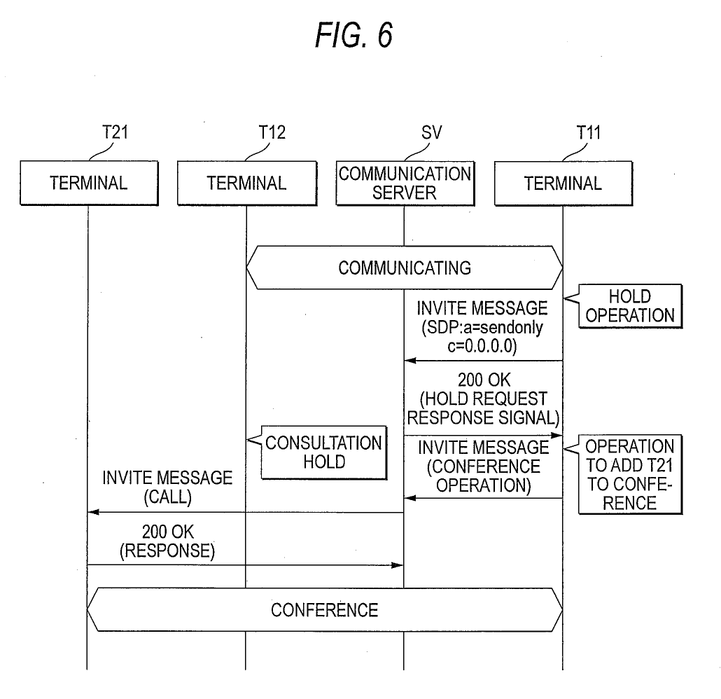

FIG. 6 is an exemplary sequence chart to show the operation to execute Consultation Hold control and a conference control according to a second embodiment of the present invention.

Now, for example, assume that voice communications are performed between a terminal T11 and a terminal T12.

In this state, assume that a user performs hold request operation to the terminal T11. Then, a request signal (INVEITE message) is sent from the terminal T11 to the communication server SV. Upon reception of the request signal, the communication server SV refers the terminal information database 15 based on the IP address of the terminals T11 and T12 included in the request signal and determines a protocol of the request signal. For example, if the protocol of the terminal T11 is SIP and the request signal includes a=sendonly or c=0.0.0.0 in SDP parameter, it is determined that the request signal is for hold operation. The communication server SV starts service of Consultation Hold and returns a hold start response to the terminal T11 while the communication link with the communicating terminal T12 is held.

Subsequently, assume that the user of the terminal T11 performs a request operation to add a terminal T21 to conference telephone conversation to the terminal T11. Then, a request signal is sent from the terminal T11 to the communication server SV.

Upon reception of the request signal, the communication server SV refers the terminal information database 15 and determines whether or not the request signal includes a SDP parameter representing conference. If a parameter representing conference is included, it is determined that the request signal is for a conference and a conference service function is started.

The communication server SV calls the terminal T21 while the communication link between the terminals T11 and T12 is held. If the user of the terminal T21 performs response operation to the call, the terminal 21 sends a response signal to the communication server SV.

Thus, the terminal T21 can be added to the conference telephone conversation between the terminal T11 and the terminal T12.

As described above, in the second embodiment, if operation for starting Consultation Hold and the conference function is performed during a communication with the terminal T12 at the terminal T11, information to start Consultation Hold and the conference function is sent from the terminal T11 to the communication server SV, which then executes requested Consultation Hold and conference function using the received information.

Therefore, Consultation Hold and the conference function in the terminal T11, T12 are implemented by Consultation Hold and the conference function that the communication server SV has, so that if either of the terminals T11 and T12 does not include a function to start Consultation Hold and the conference function, Consultation Hold and conference services can be implemented.

### Other Embodiment

The invention is not limited to the specific embodiments described above. For example, in the description of the embodiments, Consultation Hold control, communication transfer control, and conference control are executed in response to request operation from a terminal by way of example. However, for example, if special number originating operation is performed after Consultation Hold is started, execution of a special number originating function is also possible.

In addition, the system configuration, the functional configuration of the communication server, the terminal types, the storage contents of the terminal information database, the procedures of the Consultation Hold control, the communication transfer control, the conference control, and the special number originating control, etc., can also be modified in various manners without departing from the spirit and the scope of the invention.

As described above, a communication system according to an embodiment makes it possible to implement additional services of hold, transfer, etc., regardless of the types of terminals for performing a communication.

As described above, if operation for starting the additional service is performed during a communication with terminals, the information to start the additional service is transmitted from one of the terminal to the server, which then can execute the requested additional service using the received information. That is, it is made possible to provide the server with the execution function of the additional service between the terminals.

Therefore, if either of the terminals does not include the additional service function or the terminals differ in communication protocol, the additional services of hold, transfer, etc., can be implemented.

The communication system further includes a terminal information database that stores a management table associating the terminal IDs and the communication protocols supported by the communication terminals with each other, and when the information to start the additional service is received from one of the terminals, the communication server refers the management table based on the terminal IDs of the terminals included in the information and executes the additional service based on the reference result.

According to the configuration, whether or not execution of the additional service is permitted is determined, etc., using the management table concerning the communication protocols of the communication terminals stored and managed in memory, so that appropriate additional service execution processing can be performed according to a simple procedure.

What is claimed is:

1. A communication system comprising:
a first terminal connected to an IP network and communicates with a second terminal through the IP network, the first terminal comprising a transmitter that transmits an instruction data for activating an additional function in response to a request operation for activating the additional function while the first terminal communicates with the second terminal; and
a server apparatus comprising a controller that controls a communication between the first and second terminals and that analyzes a received data by the server apparatus,
wherein, when it is analyzed that the received data includes the instruction data for activating the additional function, the controller performs the additional function based on the instruction data.

2. The communication system according to claim 1,
wherein the transmitter transmits a first instruction data for activating a consultation hold function in response to a request operation for holding the communication between the first and second terminals,
wherein the controller performs the consultation hold function based on the first instruction data.

3. The communication system according to claim 2,
wherein the first terminal transmits a second instruction data for activating a transferring function in response to a request operation for transferring to a third terminal after the request operation for holding the communication, and
wherein the controller switches a party with which the second terminal communicates from the first terminal to the third terminal based on the second instruction data.

4. The communication system according to claim 2,
wherein the transmitter transmits a second instruction data for activating a conference function in response to a request operation for adding a third terminal to the communication between the first and second terminals, after the request operation for holding the communication, and
wherein the controller adds the third terminal to the communication between the first and second terminals based on the second instruction data.

5. The communication system according to claim 2,
wherein the transmitter transmits a second instruction data for activating a special service function in response to a request operation for originating a call for a special service number after the request operation for holding the communication, and
wherein the controller performs the special service function based on the second instruction data.

6. The communication system according to claim 1,
wherein the first terminals includes an IP terminal capable of activating the additional function.

7. The communication system according to claim 1,
wherein the server apparatus further comprises a storage that stores a table respectively associating terminal IDs assigned to the first and second terminals and communication protocols supported by the first and second terminals with each other, and
wherein, when the server apparatus receives the data, the server apparatus refers the table based on the terminal IDs included in the received data and performs the additional function using a reference result.

8. A server apparatus comprising:
a communication controller that controls a communication between a first terminal and a second terminal through an IP network;
a receiver that receives a data from the first terminal while the first terminal communicates with the second terminal;
an analyzing unit that analyzes the received data; and
a controller that, when it is analyzed that the received data includes an instruction data for activating an additional function, performs the additional function.

9. The server apparatus according to claim 8, further comprising:
a storage that stores a table respectively associating terminal IDs assigned to the first and second terminals and communication protocols supported by the first and second terminals with each other,
wherein the analyzing unit refers the table based on the terminal IDs included in the received data to determine the communication protocols supported by the first and the second terminals and analyzes the received data according to the determined communication protocols, and
wherein the controller performs the additional function according to the determined communication protocol supported by the first and second terminals.
